(19) United States
(12) Patent Application Publication
(10) Pub. No.: US 2005/0256639 A1
(43) Pub. Date: Nov. 17, 2005

(54) Method and system for dynamically navigating a vehicle to its destination

(76) Inventors: Mario Aleksic, Trossingen (DE); Cesim Demir, Aidlingen (DE); Martin Keppler, Oberreichenbach (DE); Werner Richter, Munich (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/512,261

(22) PCT Filed: Apr. 22, 2003
(86) PCT No.: PCT/EP03/04160

§ 371 Date: May 23, 2005

(30) Foreign Application Priority Data
Apr. 25, 2002 (DE) 102 18 636.7

(51) Int. Cl. G01C 21/34

(52) U.S. Cl. 701/210; 701/202; 340/995.13; 340/995.21

(57) ABSTRACT

A method for dynamically navigating a vehicle to its destination, whereby a vehicle-mounted device wirelessly requests route-related data for a driving destination from a traffic center, whereupon the traffic center calculates and stores a route to the driving destination for the vehicle and wirelessly transmits route-related data to the vehicle-mounted device. At least one interruption in traffic flow, which is not located on the calculated route, is monitored in the traffic center and the calculated route is, at least in part, recalculated in the event this interruption in traffic flow eases.

The invention relates to a method for dynamically navigating a vehicle as claimed in the preamble of patent claim 1 and to a system for dynamically navigating a vehicle as claimed in the preamble of patent claim 19.

When a vehicle is dynamically navigated, the current traffic situation and the future traffic situation which is predicted to occur in the course of the journey to the destination is taken into account in the selection of a route to the destination. In this context, on the one hand, what are referred to as “on-board methods” are used in which the route to the destination is determined in a vehicle-mounted device. On the other hand, “off-board methods” are used in which the route is calculated in a traffic control center. In on-board methods, the traffic situation which is used to determine the route is made available to the vehicle-mounted device in a wireless fashion, and in off-board methods the traffic situation is stored in the traffic control center and the calculated route is transmitted to the vehicle-mounted device in a wireless fashion. The data which is made available to the vehicle-mounted device in a wireless fashion and which relates to the traffic situation—for example traffic disruptions—or the calculated route, is referred to below in combination as route-related data.

DE 19547574 A1 proposes that route-related data should be transmitted from a traffic control center to a vehicle-mounted device in a wireless fashion, a simulation of the journey of the vehicle being carried out in real time in the traffic control center and/or in the vehicle-mounted device.

EP 0838797 A1 discloses a vehicle-mounted device which is configured to receive route-related data. When a destination and starting location of the vehicle are predefined, a first route is determined without taking into account route-related data. Furthermore, a second route is determined taking into account received, route-related data, insofar as the received, route-related data relates to the first route. If the predicted travel time on the second route is shorter than the predicted travel time on the first route, selection information is issued to the driver. The selection information offers the second route as an alternative route to the first route.

DE 19956108 A1 develops the subject matter of EP 0838797 A1. In this respect, DE 19956108 A1 proposes that the vehicle-mounted device should carry out a plurality of route-determining operations for alternative routes if received, route-related data relates to the specific first route. In this context, alternative routes are determined for a plurality of branching off points at which it is possible to leave the calculated first route, and corresponding selection information is issued to the driver.

The genus-forming EP 0974137 B1 discloses a method in which a vehicle-mounted device receives route related data from a traffic control center in a wireless fashion. If a traffic disruption is detected on the calulated route in the traffic control center, the traffic control center acquires a new route and transmits it to the vehicle-mounted device in a wireless fashion.

The object of the present invention is to propose a universal method for dynamically navigating a vehicle, which takes into account traffic disruptions which are relevant for the vehicle and always ensures an optimum route in a cost-effective fashion. The object of the invention is also to propose a corresponding system.

The invention achieves this object with respect to the method by means of the features of patent claim 1, and with respect to the system by means of the features of patent claim 19. The subclaims relate to advantageous embodiments and developments.

According to the invention, at least one traffic disruption which is not located on the calculated route is monitored in the traffic control center, and when this traffic disruption decreases the calculated route is at least partially recalculated. In other words, the device relates, for example, to the case in which there is an alternative route to the calculated route and the alternative route would be the “better” route if a traffic disruption were not located on it. In this context, “better” means, for example, shorter or more cost-effective. For this reason, if this traffic disruption decreases, for example clears, the route is at least partially recalculated. As a result, a route which is the “best” route for the vehicle is always calculated according to the invention.

While it is already known to monitor a calculated route to determine whether a traffic disruption occurs on it, here the case in which traffic disruptions are not located on the calculated route is considered. According to the invention, a new route is calculated for the vehicle only if such a traffic disruption decreases. This is because if, for example, such a traffic disruption “becomes worse”, a recalculation of the route will under no circumstances give rise to a route other than the calculated route. In addition, a corresponding selection of the traffic disruptions to be monitored ensures that not all the traffic disruptions are monitored, but instead only “relevant” traffic disruptions are monitored. A traffic disruption is, for example “relevant” and is thus monitored if it is located on a possible alternative route to the calculated route. As a result, the invention ensures a procedure for dynamically navigating a vehicle using a traffic control center which is optimized in terms of cost. This is because a transmission of route-related data, which usually entails costs, is not carried out whenever the traffic situation changes, but rather only when a monitored traffic disruption decreases. The method according to the invention can be used in this context in a universal fashion both for on-board navigation and for off-board navigation as well as for hybrid forms (hybrid navigation). In addition, the computational work in the vehicle-mounted device and in the traffic control center is minimized both for on-board navigation and off-board navigation by virtue of the fact that it is not necessary to redetermine or recalculate the route whenever the traffic situation changes. Such redetermination or recalculation is necessary only when a monitored traffic disruption decreases. The method according to the invention thus ensures, in a universal way, a procedure which is optimized in terms of costs.

The traffic disruptions which are to be monitored and which are not located on the calculated route can be selected easily in terms of computing equipment if all the traffic disruptions which are located in a predefinable region around the calculated route are monitored. The predefinable region around the calculated route may, for example, be in the form of a corridor around the route.

In one particularly preferred embodiment, information is transmitted to the vehicle-mounted device in a wireless fashion by the traffic control center if there is a change in the recalculated route in comparison with the calculated route. As a result, the vehicle-mounted device is informed immediately of a possible change, and the driver of the vehicle can, for example, subsequently request route-related data from the traffic control center in a wireless fashion. In this context, it is possible to serve the vehicle individually since the calculated route is stored in the traffic control center, and the route on which the vehicle is traveling is always known in the traffic control center. Since the vehicle-mounted device and/or the driver of the vehicle himself knows the precise location of the vehicle, a targeted decision about whether new route-related data is to be requested from the traffic control center is thus possible. The transmission of route-related data which usually entails costs is therefore initiated at the vehicle end only if it is advantageous for the vehicle, and it is not initiated whenever the recalculated route changes. In this context, the information which is transmitted by the traffic control center in a wireless fashion can also contain data indicating whether the newly calculated route provides an advantage, for example a time advantage, in comparison with the calculated route, and how large this advantage is.

It is advantageous if the traffic control center transmits, in addition to route-related data, at least one location of a change in the route and at least one time of change, together with the calculated route, to the vehicle-mounted device. For example, when a route is calculated, a future traffic situation is estimated using an assumed course of the journey of the vehicle. If the vehicle then has a different course of journey than the estimated one, for example because the vehicle stops en route, the traffic situation which is to be estimated may have changed. This would in turn cause another route to be calculated. If the location and the time of the predicted change in the calculated route are present in the vehicle-mounted device, a simple (also automatic) decision as to whether new, usually cost-incurring, route-related data is to be requested from the traffic control center is possible at the vehicle end. In this context, a “starting time”, starting from which a calculated route “applies”, and/or an “end time”, starting from which a calculated route no longer “applies”, are provided as times of change. In addition, or alternatively, it is possible to provide for the traffic control center to transmit information about the course of the journey—assumed in the traffic control center—of the vehicle on the calculated route to the vehicle-mounted device. The assumed course of the journey is mapped, for example, as an assumed, average vehicle velocity. Likewise, it is additionally possible to provide for the traffic control center to transmit, to the vehicle-mounted device, route-related data relating to a newly calculated route starting from the location of a change in the route.

It is advantageous to propose that the route is recalculated only if a traffic disruption which is not located on the calculated route decreases by more than a predefinable degree. As a result of using such a threshold value, the frequency of the recalculation of the route is reduced without having to accept relatively severe reductions in precision.

In one preferred embodiment of the invention, the route-related data is in the form of traffic data. This corresponds to the embodiment of the invention as an on-board navigation system. In this context, the traffic control center transmits traffic data to the vehicle-mounted device in a wireless fashion, and the vehicle-mounted device uses the received traffic data to navigate the vehicle dynamically by using the traffic data to determine a route. For example, the traffic disruptions which are “relevant” for the vehicle, i.e. are monitored in the traffic control center, are transmitted as traffic data. It is possible to provide in this context for the traffic data to be compiled individually for the vehicle in the traffic control center. Such “individualized” traffic data is obtained, for example, by transmitting the location of the vehicle when the route-related data is requested from the vehicle end. In particular, if information is transmitted from the traffic control center to the vehicle-mounted device in a wireless fashion when the route which is recalculated in the traffic control center changes in comparison with the calculated route, up-to-date, individualized traffic data can always be requested by the vehicle-mounted device under real-time conditions.

In a further preferred embodiment of the invention, the route-related data is in the form of route data. This corresponds to the embodiment of the invention as an off-board navigation system. In this context, a route for the vehicle is calculated in the traffic control center using, for example, the monitored traffic disruptions, and this calculated route is then made available to the vehicle-mounted device in a wireless fashion.

It is advantageously proposed that, in the case of on-board navigation, i.e. when the route-related data is in the form of traffic data, information relating to the course of a calculated or determined route is additionally transmitted in a wireless fashion between the vehicle-mounted device and traffic control center. For example, what are referred to as routing points, i.e. “reference points” located on the calculated or determined route, are used to ensure that the traffic control center and vehicle-mounted device calculate or determine the same route. To do this, the vehicle-mounted device, or the traffic control center, selects suitable points lying on the route and transmits them, for example together with the respective request or transmission of route-related data. In addition it is possible to provide that when the route determined in the vehicle-mounted device fails to correspond to the route calculated in the traffic control center, corresponding information is transmitted in a wireless fashion. The correspondence is checked here in that, for example in the vehicle-mounted device, the information relating to the course of the route calculated in the traffic control center is used to reconstruct this route and is compared with the route which is determined in the vehicle-mounted device itself. This ensures that the route determined in the vehicle-mounted device and the route calculated in the traffic control center correspond even if respectively different matching and/or routing methods and/or databases (digital road maps) are used. Alternatively or additionally there is provision in the traffic control center to use the information relating to the course of the route calculated in the vehicle-mounted device to reconstruct this route and to compare it with the route determined in the traffic control center itself. In this context, it is also possible for such a reconstructed route also to be used in the traffic control center (for example to select traffic disruptions to be monitored), if the reconstructed route does not correspond to the route determined in the traffic control center itself.

It is also advantageous, in the case of on-board navigation, for information relating to the predefinable region to be additionally transmitted between the vehicle-mounted device and traffic control center. For example, the vehicle-mounted device can interrogate, from the traffic control center, a specific predefinable region and thus be informed about the traffic disruptions located in this region, or the traffic control center informs the vehicle-mounted device about the size of the predefined region. This reliably ensures that the vehicle is served in the best possible way at the lowest possible cost. As a result, for example when the vehicle leaves the route, when a new destination is selected or when an intermediate destination is headed for by the vehicle, new traffic data is requested from the traffic control center only if a part of the new route lies outside the predefinable region, i.e. in an area without route-related data. This request can be made manually by the driver or in an automated fashion. In other words, in this way the information relating to the predefinable region in the vehicle-mounted device ensures, when the vehicle makes a change in the route which lies inside the predefinable region, that route-related data for the new route is also present in the vehicle-mounted device.

A recalculation of the route in the traffic control center is simplified if only the part of the calculated route through which the vehicle has not yet traveled, assuming a minimum velocity, is recalculated. Such a minimum velocity may, for example, be read out from corresponding databases. It is particularly advantageous if three recalculations of the route are carried out using three different average velocities of the vehicle on its route. These three average velocities correspond to a statistically slowest driving style, fastest driving style and average driving style. Such statistical data is acquired, for example, from historic starting point/destination relationships which have been stored together with travel time information. This takes into account the fact that the exact location of the vehicle is not known in the traffic control center. These three recalculations specifically permit “decision points”, at which the vehicle can leave the precalculated route in order to change to the newly calculated route, to be taken into account in an optimum way. By using three different average velocities, all the practical application situations relating to the location of the vehicle are covered. For example, if the newly calculated route changes in comparison with the calculated route, the traffic control center transmits, in a wireless fashion, information to the vehicle-mounted device which includes decision points. By comparing the current location of the vehicle with the decision points it is possible to select the decision point which is best for the vehicle, i.e. is closest on its route.

It is advantageously proposed that the traffic disruption, or each traffic disruption, be monitored at least for a period of time which it is estimated, at the traffic control center, that the vehicle will take to reach the destination. This ensures, in a particularly simple way, that the vehicle is served in an optimum way during the entire journey. The period of time which it is estimated that the vehicle will take to reach the destination can be estimated, for example, using a minimum velocity.

A time of arrival at the destination which is determined at the vehicle end, for example estimated, is advantageously additionally transmitted in a wireless fashion from the vehicle-mounted device to the traffic control center. This makes it possible to determine reliably the period of time for which the traffic disruption, or each traffic disruption, is monitored in the control center. For example, for this purpose, the vehicle-mounted device transmits corresponding information to the traffic control center, together with the request for route-related data. When the time of arrival at the destination is reached, the monitoring of the traffic disruption, or of each traffic disruption, in the traffic control center is terminated. In addition, the time of arrival at the destination can also be stored in the vehicle. If the time of arrival at the destination is then updated in the vehicle at specific time intervals, the up-dated time of arrival at the destination can be transmitted to the traffic control center when a predefinable deviation between the up-dated and the stored times of arrival at the destination is exceeded. As a result, the period of time for which the traffic disruption, or each traffic disruption, is monitored in the traffic control center is adapted precisely to the course of the journey of the vehicle. This takes into account if, for example, the vehicle requires a greater deviation (for example if the vehicle travels more slowly than estimated or if it interrupts its journey en route) or a smaller deviation (for example if the vehicle travels more quickly than estimated) than the predefinable deviation in order to reach its destination. Alternatively or additionally there is provision that the current location of the vehicle is transmitted to the traffic control center by the vehicle-mounted device when such a deviation is detected. As a further alternative or in addition there is provision that after the reception of route-related data from the traffic control center, the vehicle-mounted device can transmit an acknowledgement to the traffic control center in an automated fashion. This reliably ensures that the monitoring in the traffic control center is terminated when the vehicle reaches its destination and/or when the navigation process is interrupted since then the vehicle-mounted device will not transmit such an acknowledgement. In order to allow for the possibility that the wireless connection between the vehicle-mounted device and traffic control center is not available for a short time, it is possible to provide for the traffic control center to wait for this acknowledgement for a specific time period after the transmission of route-related data to the vehicle before the monitoring of the traffic disruption, or of each traffic disruption, is terminated.

It is particularly advantageous if, in order to determine traffic disruptions which are to be monitored, in a first step a route R₁ to the destination is calculated without taking into account traffic disruptions, in a second step a route R_{A} to the destination is calculated taking into account all the traffic disruptions, in a third step all the traffic disruptions on R₁ are monitored and a route R₂ to the destination is calculated taking into account only the traffic disruptions which have already been monitored, in a fourth step all the traffic disruptions on the previously calculated route Rᵢ, i≧2, are monitored and a route Rᵢ₊₁ to the destination is calculated taking into account the monitored traffic disruptions, and the fourth step is repeated until the route Rᵢ corresponds to the route R_{A}, and all the possibly existing traffic disruptions on R_{A} have already been monitored in a previous step. By means of this procedure, on the one hand only traffic disruptions which are located on routes which may be a new route for the vehicle if recalculation takes place are determined. On the other hand, only traffic disruptions which could provide a modified route given recalculation of the route if the traffic disruptions decrease or clear, are monitored. Therefore, only “relevant” traffic disruptions on “relevant” routes (i.e. alternative routes) are monitored. In this context, alternative routes are routes which could be calculated as a new route for the vehicle if one or more traffic disruptions clear.

The first advantage results from the fact that in each step routes which are “optimum” taking into account some of the traffic disruptions which are actually present are calculated. In other words, these routes would be optimum if traffic disruptions which are not monitored were cleared. Since only traffic disruptions on the routes which are calculated in this way are monitored, this in fact results in the first advantage. The second advantage is indicated by proof of a contradiction. Assuming there were a route Rₓ on which one or more disruptions S1, . . . , Sn were located and which were not monitored by the described method. And also assuming that, if these disruptions S1, . . . , Sn were cleared, this route Rₓ would be better than the route R_{A} calculated taking into account all the traffic disruptions. Since the significant factor is whether the traffic disruptions S1, . . . , Sn have to be monitored in order to detect a change in the optimum route, the assumption that all the traffic disruptions are cleared completely also covers all the other cases. The clearing of disruption is the most wide ranging change which would remain undetected if the traffic disruptions were not monitored. According to the assumption, S1, . . . , Sn are not monitored and are thus not taken into account in the determination of the route. This corresponds, in terms of the route calculation, to the case in which all the traffic disruptions have cleared. However, since in this situation Rₓ becomes better than R_{A}, route Rₓ is also determined as an optimum route Rᵢ before an abort criterion is reached. However, according to the method, all the disruptions S1, . . . , Sn are then marked as to be monitored, which contracts the assumption.

Usually, only a small number of traffic disruptions have to be monitored so that the work in the traffic control center to calculate the route to the destination requires only a small degree of computing work. However, in order to reliably prevent the computing work becoming too large, it is advantageously proposed that the number of routes Rᵢ to be calculated be limited to a predefinable maximum value n. As a result, the most important traffic disruptions are monitored with a minimized degree of computing work.

One advantageous development is obtained from the fact that further routes Rᵢ are calculated, for example at a later time. For example, the further routes Rᵢ are calculated when the computing load on the traffic control center is low. As a result, overloading of the traffic control center is prevented at peak times, but nevertheless all the traffic disruptions are monitored.

The invention is preferably implemented as a computer program with program code means, a respective embodiment of the method according to the invention being carried out if the respective program is carried out on a computer.

A further preferred embodiment of the invention constitutes a computer program product with program code means, the program code means being stored on a computer-readable data carrier in order to implement a respective embodiment of the method according to the invention if the respective program product is executed on a computer.

The invention is explained in more detail below with reference to drawings, in which:

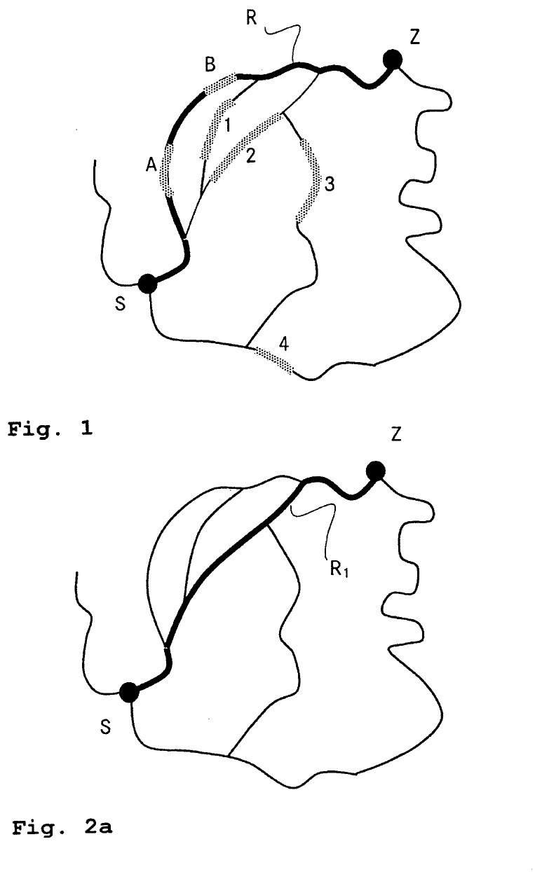

FIG. 1 is a schematic view of various traffic disruptions in the case of dynamic navigation,

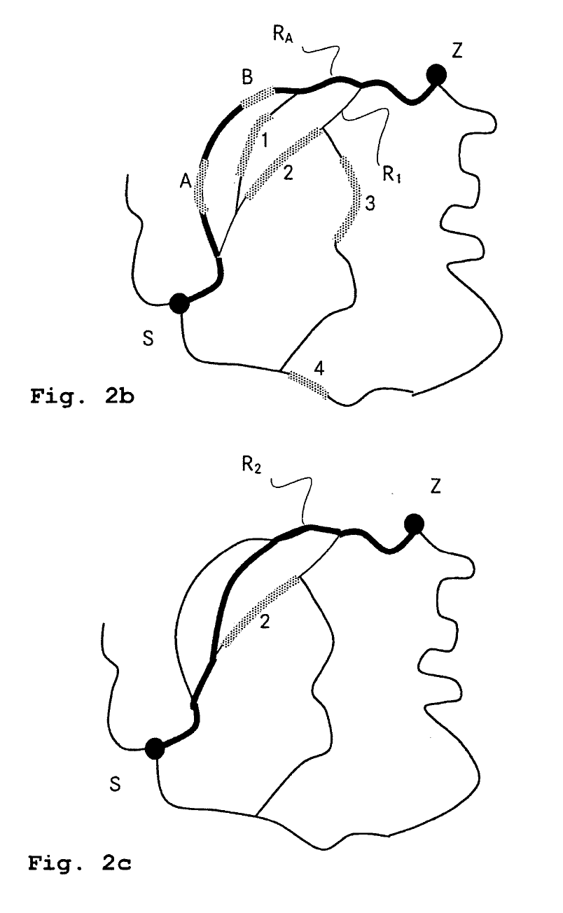

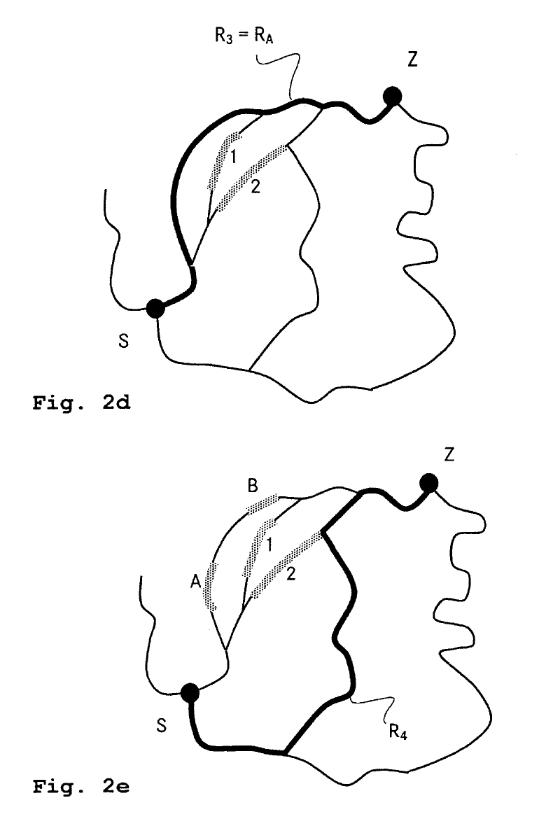

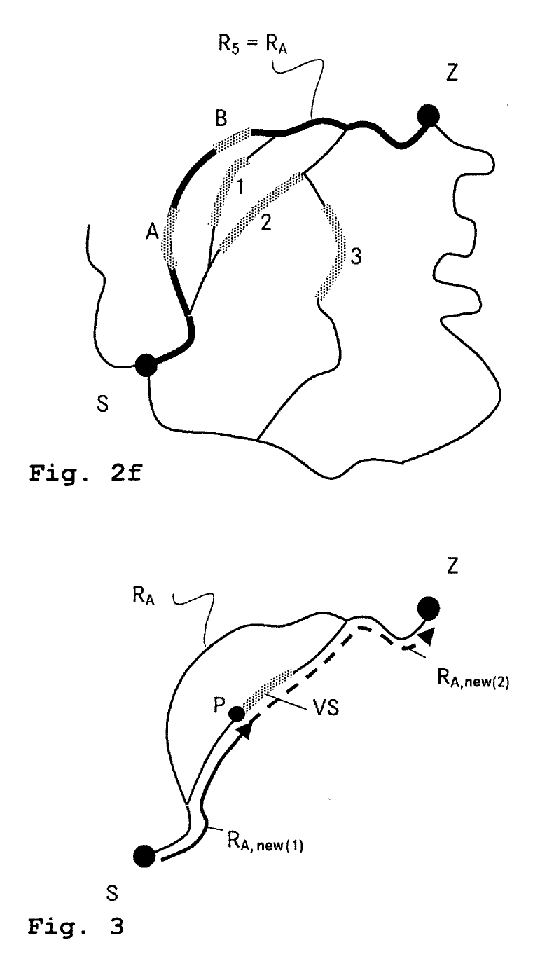

FIGS. 2 a, b, c, d, e, f show steps of a preferred embodiment of the method according to the invention during the selection of traffic disruptions to be monitored,

FIG. 3 is an outline of marginal costs associated with a disruption,

FIG. 4 shows decision points on a calculated route,

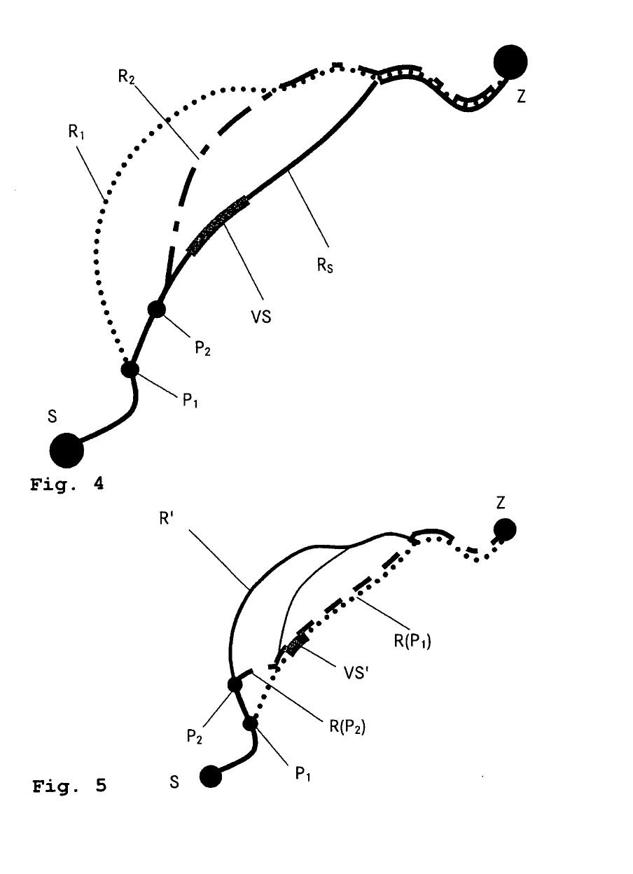

FIG. 5 shows decision points on a route which has been recalculated owing to a traffic disruption decreasing,

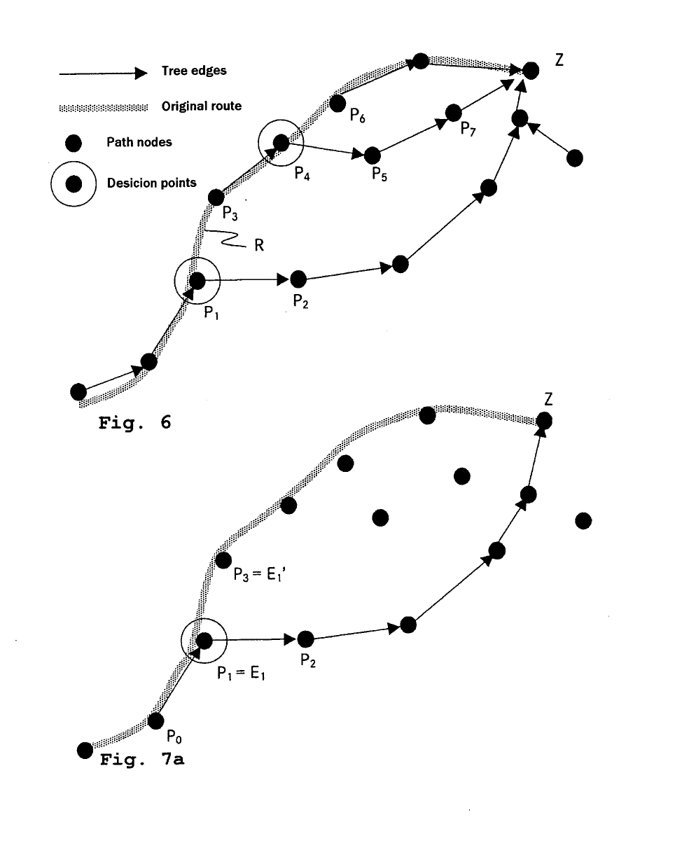

FIG. 6 shows a determination of decision points by calculating a “shortest path tree”,

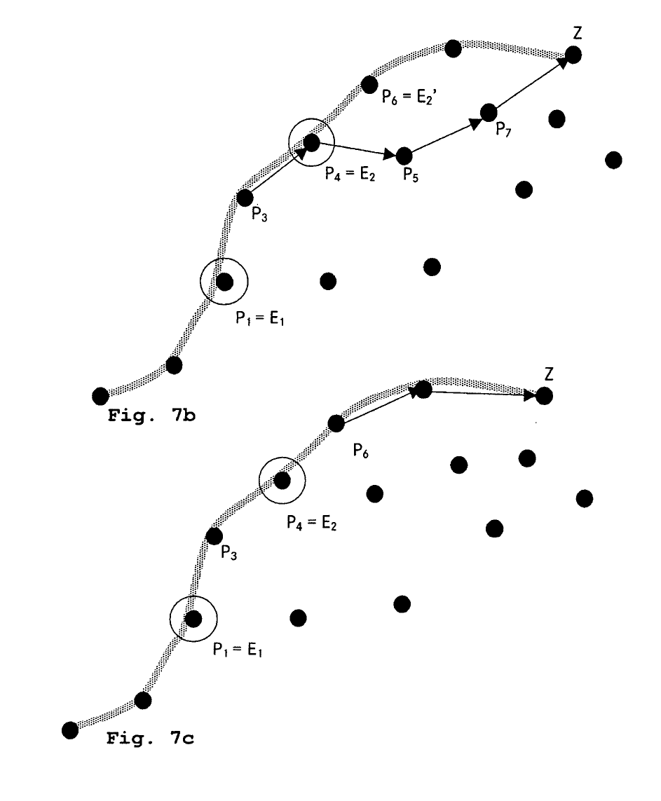

FIGS. 7 a, b, c show the determination of the decision points by means of a sequence composed of a plurality of route calculations,

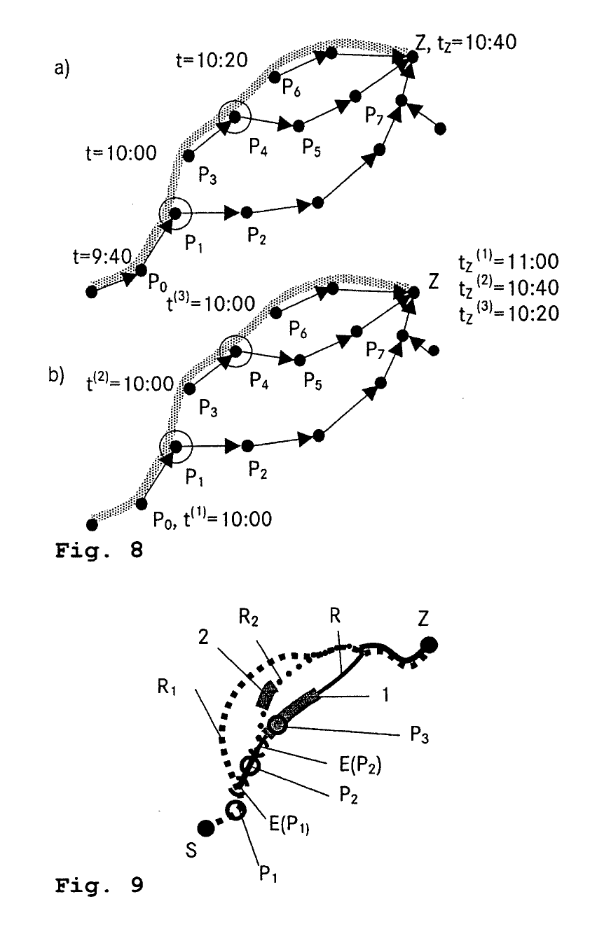

FIGS. 8 a, b show differences between the calculation of the “shortest path tree” and separate component route calculations,

FIG. 9 shows the use of decision points in association with vehicle locations,

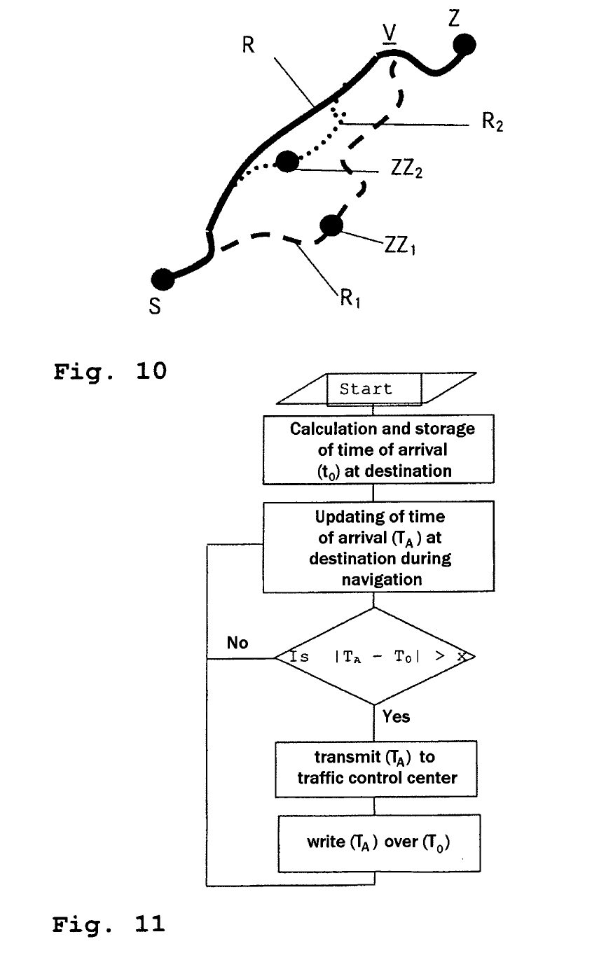

FIG. 10 shows a use of information relating to the predefinable region,

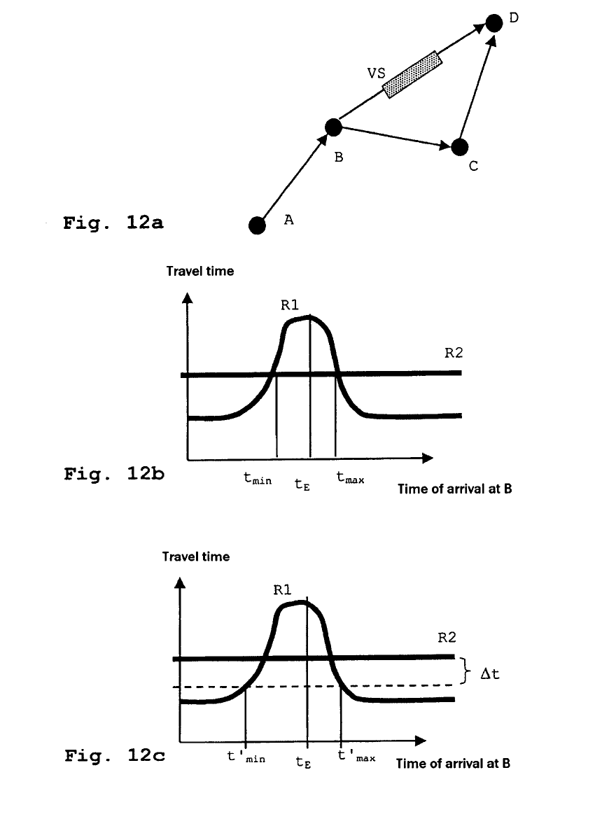

FIG. 11 shows the use of a time of arrival at a destination which is determined at the vehicle end,

FIGS. 12 a, b, c are schematic views of the use of a location of a change in a route, with the time of a change in a calculated route,

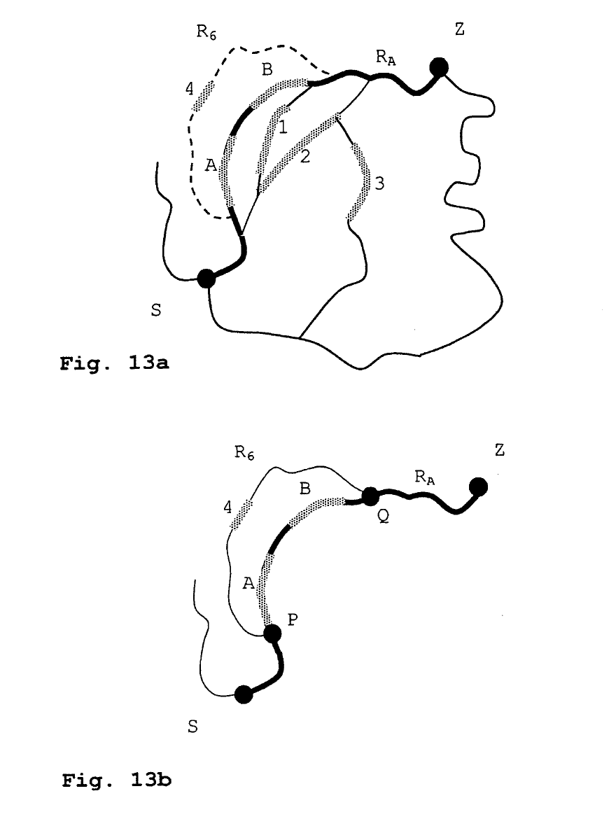

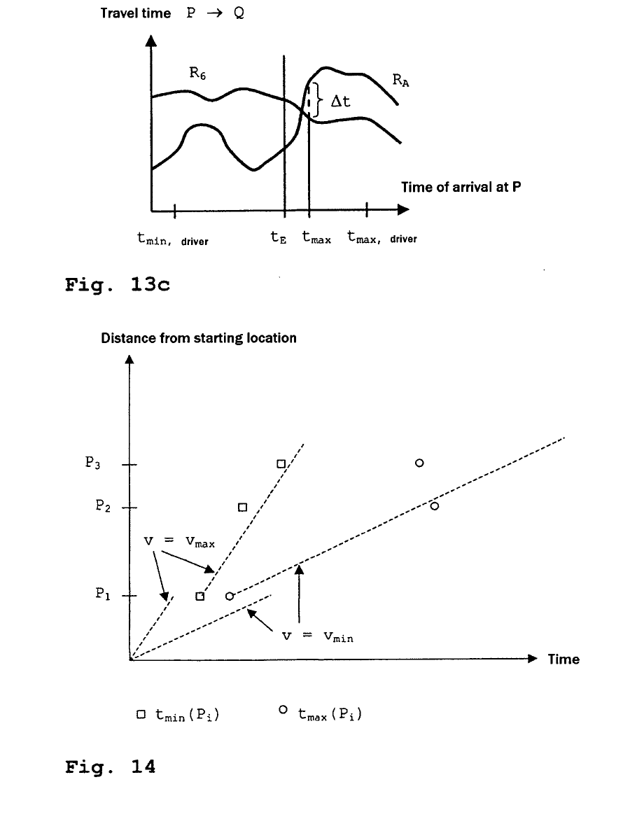

FIGS. 13 a, b, c show the use of locations of changes in routes with times of change in a calculated route, and

FIG. 14 shows which data relating to locations of changes in routes are transmitted from the traffic control center to the vehicle-mounted device.

FIG. 1 is a schematic illustration of various traffic disruptions in the case of dynamic navigation from a starting location S to a destination Z. Conventionally, traffic disruptions A, B which are located on a route R which has been calculated for a vehicle are monitored. In this context, the route is recalculated when the traffic situation on this route becomes worse, i.e. either when A and/or B become worse and/or when a new traffic disruption arises; in contrast when the traffic situation on the calculated route improves a recalculation is not carried out.

In a novel fashion, “relevant” traffic disruptions which are not located on the calculated route R are now additionally monitored. In this context “relevant” means that a decrease in the traffic disruption or clearing of the traffic disruption would give rise to another route. The traffic disruptions 1, 2, 3, 4 in FIG. 1 are not located on the calculated route R. The traffic disruptions 1, 2, 3, 4 are located on alternative routes from the starting location S to the destination Z. If one of the traffic disruptions 1, 2, 3 were to decrease or clear—and the traffic disruptions on the calculated route R were to remain unchanged—the corresponding alternative route would be “better”. For this reason, the traffic disruptions 1, 2, 3 are “relevant” and are monitored. In contrast, traffic disruption 4 lies on a section of road which leads to the destination Z only via a very long detour. Even if traffic disruption 4 were to clear, this would not produce a better alternative to the calculated route R. For this reason, traffic disruption 4 is not relevant and is not monitored. It is to be noted that a change in the calculated route as a result of the traffic situation outside the calculated route R worsening (i.e. as a result of one or more traffic disruptions 1, 2, 3, 4 increasing and/or a new traffic disruption coming about) is not possible.

It is also to be noted that, in addition to the “relevant” traffic disruptions 1, 2, 3, traffic disruption 4 in FIG. 1 could also be considered relevant given a corresponding selection of the predefinable region within which traffic disruptions are monitored. Although a decrease in or clearing of this traffic disruption 4 would not give rise to a change in the route, the route would be recalculated in this case. However, the traffic control center would not transmit any information to the vehicle-mounted device since the newly calculated route corresponds, of course, to the (previously calculated) route R. Given a “generous” selection of the predefinable region, the small amount of computing work involved in the original route request by the vehicle-mounted device when “relevant” traffic disruptions are determined contrasts with a larger amount of computing work when the traffic situation is improved, with a larger number of traffic disruptions to be taken into account when the route is recalculated. As a result of the selection of a smaller region, the computing work involved in the recalculation of the route can be reduced, but possibly “relevant” traffic disruptions are considered to be “not relevant”. In every case, a recalculation of the route is carried out here when the traffic situation improves by a predefined degree.

FIG. 2 shows steps of a preferred embodiment of the method according to the invention during the selection of traffic disruptions to be monitored. Here, FIG. 2a shows the calculation of the optimum route R₁ without taking into account traffic disruptions (first step), FIG. 2b shows the calculation of the route R_{A} taking into account all the traffic disruptions (second step), FIG. 2c shows the selection of the traffic disruption 2 on R₁ as “relevant” and the calculation of route R₂ taking into account this traffic disruption (third step), FIG. 2d shows the selection of the traffic disruption 1 and the calculation of route R₃, the route R₃ corresponding to the route R_{A} (fourth step; since some of the traffic disruptions on R_{A} have still not been marked, further route calculations must take place), FIG. 2e shows the selection of traffic disruptions A and B and the calculation of route R₄ (first repetition of fourth step) and FIG. 2f shows the selection of traffic disruption 3 and the calculation of route R₅, the route R₅ corresponding to the route R_{A} (second repetition of fourth step, since traffic disruptions A and B have already been marked in an earlier step, the process is aborted here).

A definition of marginal costs G(VS) of a traffic disruption VS is shown in FIG. 3. A component route R_{A, new (1)} from the starting location S to the start of the traffic disruption VS (the location P), a component route R_{A, new (2)} from the start of the traffic disruption VS (the location P) to the destination Z, a calculated route R_{A} and the traffic disruption VS are illustrated.

Each traffic disruption VS which is recognized as being “relevant” is assigned costs K(VS) which include, for example, the resulting waste of time. Furthermore, marginal costs G(VS), the undershooting of which allows the calculated route to be changed, are determined. The marginal costs G(VS) are selected here in such a way that if there is a change in the calculated route when there is any traffic disruption VS, the marginal costs are undershot. Conversely, the marginal costs may be undershot in the event of a traffic disruption even though the newly calculated route remains unchanged, i.e. the same as the route which has already been calculated.

In order to derive the specified marginal costs G(VS), the traffic disruption VS whose costs drop to a lower value K_{new}(VS) and as a result bring about a change in the calculated route is considered. All the other “relevant” traffic disruptions remain unchanged. The travel time along the newly calculated route R_{A, new} is then determined. Since the newly calculated route has been brought about in accordance with the condition that the traffic disruption VS decreases, the R_{A, new} must run through VS. The route R_{A, new} is therefore composed of a part R_{A, new (1)}, which runs from the starting location S as far as the start of the traffic disruption VS at the location P, and a part R_{A, new (2)} which runs from the location P to the destination Z through the disruption S. In this respect it is assumed that it is not possible to turn off from the section of road along the part of the route where there is the traffic disruption VS. If this were the case, R_{A, new} would not necessarily run through the entire traffic disruption VS and the marginal costs under consideration here would not ensure that a change in the calculated route would be detected.

In the original route request, the traffic disruption VS was selected as “relevant” when a route Rᵢ, on which the traffic disruption VS is located, was calculated from the starting location S to the destination Z. Rᵢ is composed of a part Rᵢ₍₁₎ from the starting location S to the location P, and a part Rᵢ₍₂₎ from P to the destination Z. Rᵢ is “optimum” on condition that only the traffic disruptions which were selected as “relevant” at the time when Rᵢ was calculated are taken into account. Since Rᵢ is then “optimum”, Rᵢ₍₁₎ and Rᵢ₍₂₎ are then “optimum” on this condition. The travel time on Rᵢ, in which it is also the case that only the traffic disruptions which have already been selected are taken into account, is designated as t*(Rᵢ), and the same applies to the travel times of the component routes Rᵢ₍₁₎ and Rᵢ₍₂₎. It is to be noted here also that the traffic disruption VS itself is not yet marked as “relevant” at the time when Rᵢ is calculated. The component route R_{A, new(1)} which is “optimum” taking into account all the traffic disruptions may have a longer travel time than, or the same travel time as t*(Rᵢ₍₁₎), where only some of all the traffic disruptions have been taken into account. Since both R_{A, new(2)} and Rᵢ₍₂₎ run through the traffic disruption VS and the costs of VS are not included in t*(Rᵢ₍₂₎), R_{A, new(2)} can only have a longer travel time than, or the same travel time as the travel time of Rᵢ₍₂₎ which is extended by the costs of the traffic disruption VS:
t*(Rᵢ₍₂₎+K_{new}(VS).

The following therefore applies:
t*(Rᵢ₍₁₎)≦t(R_{A, new(1)})
and
t*(Rᵢ₍₂₎)+K_{new}(VS)≦t(R_{A, new(2)}),
and thus the following also applies:
t*(Rᵢ)+K_{new}(VS)≦t(R_{A,new}).

Since R_{A,new} is, according to the condition, more favorable than the originally calculated route R_{A}, it is also true that:
t(R_{A, new})<t(R_{A})
and thus
t*(Rᵢ)+K_{new}(VS)<t(R_{A}) and, respectively, K_{new}(VS)<t(R_{A})−t*(Rᵢ).

For this reason, the marginal costs G(VS)=t(R_{A})−t*(Rᵢ) are selected. This value can be calculated during the determination of “relevant” traffic disruptions during the original route request, and whenever the traffic situations changes it is easily possible to check whether it is undershot.

In order to ensure that a change in the “optimum” route is detected even in the case of traffic disruptions which extend over a plurality of successive parts of a route, such traffic disruptions can be divided into one portion per affected part of a route. In other words, traffic disruptions VS which extend over a plurality of parts k₁, . . . kₙ of a route can be divided into a plurality of traffic disruptions S₁, . . . Sₙ which are each considered as an independent traffic disruption, each traffic disruption Sᵢ including the portion of the traffic disruption S which is located on the part kᵢ of the route.

The concept of the decision points will be explained in more detail with reference to FIG. 4 and FIG. 5. Here, FIG. 4 shows decision points on the calculated route, and FIG. 5 shows decision points on the route which has been newly calculated owing to a decrease in a traffic disruption. Decision points are used by the traffic control center, when there is a change in the calculated route, to inform the vehicle, without precise knowledge of the location of the vehicle, about the points, i.e. locations of the originally calculated route, at which changing to an alternative route would provide a cost advantage (for example advantage in terms of time). If the vehicle leaves the originally calculated route at the next decision point lying in the direction of travel of the vehicle, the largest cost advantage can be obtained. For this reason, this point is selected and displayed by the vehicle-mounted system. It is then possible for a decision to be made, for example by the driver of the vehicle or automatically, as to whether said driver starts a possibly cost-incurring request for new route-related data (traffic data in the case of on-board navigation or route data after the route has been recalculated in the case of off-board navigation) for the anticipated cost advantage.

Decision points P₁, P₂ and routes R₁, R₂, Rₛ and a traffic disruption VS are illustrated in FIG. 4. Here, the “optimum” route has changed owing to a traffic disruption VS which has recently occurred on the originally calculated route Rs. Depending on the location of the vehicle, one of the two alternative routes or the original route is the most favorable. If the vehicle is located before the decision point P₁, R₁ is therefore the “best” route. If the vehicle is located between the decision points P₁ and P₂, R₂ is therefore the “best” route. If the vehicle is located after the decision point P₂, Rₛ is therefore the “best” route.

The principle of the decision points can also be applied if the calculated route changes as a result of a decrease in, or clearing of, a relevant disruption. This is shown in FIG. 5. In turn, decision points P₁, P₂ and routes R′, R(P₁), R(P₂) and a traffic disruption VS′ are illustrated. Here, the “optimum” route R′ has changed as a result of the monitored traffic disruption VS′ decreasing. After the recalculation, the “optimum” route includes the section of road with the monitored traffic disruption VS′. If the vehicle is located before the decision point P₁, R(P₁) is therefore the “best” route. If the vehicle is located between the decision points P₁ and P₂, R(P₂) is therefore the “best” route. If the vehicle is located after the decision point P₂, the originally calculated route R′ is therefore the “best” route.

FIG. 6 shows how decision points are determined by calculating a “shortest path tree”. Here, the shortest path tree (“tree”) is calculated according to a method which is known per se, for example the Dijkstra algorithm, with the shortest paths to the destination Z. This constitutes a route calculation using route nodes (“nodes”) of a route network, for example a digital road map. Furthermore, the originally calculated route R is indicated. Node P₁ on the tree is followed by node P₂, which is not located on the original route R. For this reason, node P₁ is the first decision point on the route. Node P₃, which follows P₁ on the original route, is, in contrast, not connected to node P₁ via a tree edge. In contrast, node P₄ follows node P₃ both on the tree and on the original route and node P₃ is therefore not a decision point. Node P₅, which follows node P₄ on the tree, does not follow P₄ on the original route so that node P₄ is the second decision point.

By tracing the nodes following a decision point on a tree it is possible also to read off the shortest path to the destination for this decision point. Thus, in FIG. 6, the shortest path from the decision point P₄ to the destination Z runs via P₅ and P₇. If there is sufficient transmission capacity when the vehicle is informed about the newly calculated “optimum” route, the course of the newly calculated “optimum” route of one or more decision points can also be included.

This procedure for determining the decision points can be implemented by means of a single, backwardly directed search for paths, a shortest path tree being calculated from the destination Z, said tree containing the optimum paths from each point of the traffic network to the destination Z. In this context, in particular a uniquely defined following node, which lies on the optimum path to the destination Z, is determined for each node on the traffic network, and the travel time on the fastest route to the destination Z is determined for each node. Those nodes on the calculated route R whose following nodes on the shortest path tree do not lie on the route R are selected and are chosen as decision points. For each decision point, the difference between the travel time on the calculated route R from the decision point to the destination Z and the corresponding travel time on the newly calculated shortest path tree is formed in order to calculate the saving in time.

Alternatively, in order to determine the decision points, the “optimum” route is firstly recalculated from the point on the calculated route R which the vehicle has already passed assuming a minimum velocity, it being presumed when taking traffic predictions into account that the vehicle is located at this point at the current time. This route will run along the calculated route R up to a first decision point Eᵢ and then branch off from it. In a second step, an “optimum” route R′ is calculated from the route Eᵢ′ which lies directly after the decision point Eᵢ calculated in the last step on the calculated route R, it being presumed that the vehicle is located at point Eᵢ′ at the current time. If this route R′ does not correspond to the original route R, this results in a further decision point Eᵢ₊₁. This second step is repeated until a maximum predefined number of iterations is reached and the decision point Eᵢ which is calculated last is after the point on the route which is the furthest point the vehicle can already have reached assuming a maximum velocity, or the route calculated last corresponds to the originally calculated route. For each decision point, the difference between the travel time on the originally calculated route is formed from the decision point for the destination Z and the corresponding travel time on the newly calculated route in order to calculate the saving in time.

FIGS. 7a, b, c illustrate the determination of the decision points by means of a sequence composed of a plurality of route calculations. Reference is made here to the initial situation which has already been shown in FIG. 6. During the first route calculation, see FIG. 7a, the starting point P₀ is selected since it is presumed that at the time t₁ of this new route calculation the vehicle has at least reached the node P₀. During this route calculation, current and predicted traffic data is taken into account on the presumption that the vehicle is located at P₀ at the time t₁. This first route calculation reveals that the “optimum” route branches off from the calculated route R at the node P₁, and for this reason P₁ is selected as the first decision point E₁. The second route calculation, see FIG. 7b, begins at node E₁, which follows node E₁′=P₃, on the calculated route R. It is then presumed that the vehicle is located at P₃ at the time t₁. During this second route calculation, the node P₄=E₂ is determined as a second decision point. The route which is obtained during the third calculation, see FIG. 7c, corresponds to the originally calculated route R, so that no further decision point is detected. The sequence of route calculations is thus terminated.

In the second alternative, more computing time has to be invested in comparison with the first alternative since in the contemporary methods a route calculation is approximately as complicated as the calculation of the shortest path tree. The advantage of the second alternative is the more correct use of traffic predictions. Allowance is made for the fact that at the time t₁ of the new route calculation the vehicle may be located at various points on the original route. As a result, the future traffic situation for each part of the route is also taken into account approximately for the time at which the vehicle can arrive there. In contrast, when the shortest path tree is calculated according to the first alternative, the time of arrival of the vehicle t_{z} at the destination Z is defined. The times of arrival of all the other parts of the route are the times at which the vehicle would have to leave there in order to reach the destination Z at the time t_{z}.

This difference is illustrated by FIG. 8: when the shortest path tree is calculated, the uniform arrival time t_{z}=10:40 hours at the destination is assumed, see FIG. 8a. This results in a departure time of 10:20 hours at P₆, 10:00 hours at P₃ and 9:40 hours at P₀. However, in reality at 10:00 hours the vehicle is located somewhere between P₀ and P₆ on the original route. For the three route calculations of P₀, P₃, and P₆ which are illustrated in FIG. 8b, in each case a departure time of 10:00 hours is assumed. This then results in the three possible arrival times 11:00 hours, 10:40 hours and 10:20 hours. As a result, the traffic situation near to the destination Z is then also taken into account for these three different times, which is not the case with the shortest path tree in FIG. 8a. As a result, when there are severe predicted changes in the traffic situation it is possible to calculate different routes and, under certain circumstances, also different decision points using the two methods. In other words, in the second alternative shown in FIG. 8b, it is assumed when each route calculation i (i=1, 2, 3) is started that the vehicle is located at the respective starting location P₀, P₃ and P₆ at t⁽ⁱ⁾=10:00 hours.

In a third alternative way of calculating the decision points, the location of the vehicle which is unknown in the traffic control center is estimated. For this purpose, for example a last destination arrival time which is determined and transmitted by the vehicle is used. When the traffic situation changes, three (possible) vehicle locations are estimated in the traffic control center, said locations being namely for the slowest driving behavior, the fastest driving behavior and an average driving behavior, and changes in the calculated route R and, if appropriate, decision points, are then determined for these estimated vehicle locations and transmitted to the vehicle.

By means of the decision points E₁ and E₂ on the originally calculated route R, nodes are determined in which, according to currently available traffic data and predictions, branching off from the calculated, i.e. original route R onto another route is more favorable than remaining on the original route R. In this context, the cost advantage (for example advantage in terms of time) which is obtained by changing onto the “more favorable” route is calculated for each decision point E₁, E₂. At least the last decision point in the direction of travel and its cost advantage are transmitted in a wireless fashion to the vehicle as part of the route-related data. Alternatively or additionally it is possible to provide for a predefinable maximum number of decision points to be transmitted with their cost advantages to the vehicle in a wireless fashion. Of course, it is also possible to dispense with transmitting a respective cost advantage.

After the reception of such a transmission, the vehicle-mounted device selects the decision point which is nearest to the vehicle in the direction of travel. The location of this decision point is then displayed to the driver of the vehicle, possibly together with the possible cost saving. The driver of the vehicle can then request route-related data in the form of the newly calculated route (off-board navigation) or the changed traffic situation (on-board navigation) from the traffic control center in a wireless fashion. In this context, the transmission which is received is ignored by the vehicle-mounted device if there is no longer a decision point in the direction of travel or the navigation process has already been terminated.

FIG. 9 shows once more the use of decision points E(P₁) and E(P₂) in association with vehicle locations P₁, P₂, P₃ with the dynamic navigation from starting location S to destination Z. The vehicle-mounted device uses the location of the vehicle to check which decision point is suitable and requests wireless, corresponding route-related data from the traffic control center in an automated fashion or when requested. If the vehicle is situated at the location P₁, branching off from the calculated route R at the decision point E(P₁) onto the newly calculated route R₁ makes it possible to drive around the traffic jam 1 and thus travel more quickly to the destination Z than if the vehicle remained on the calculated route R, despite the greater length of the newly calculated route R₁ in comparison with the calculated route R. If the vehicle is situated at the location P₂, branching off from the calculated route R at the decision point E(P₂) onto the newly calculated route R₂ still makes it possible to drive around the traffic jam 1 and thus travel more quickly to the destination Z than if the vehicle remained on the calculated route R despite the fact that the short traffic jam 2 is located on the newly calculated route R₂. If, in contrast, the vehicle is at the location P₃, there is no longer a decision point which would permit the vehicle to branch off from the calculated route R and thus drive around the traffic jam 1.

FIG. 10 illustrates the use of information relating to the predefinable region. Since the vehicle no longer has any route-related data for the destination Z after it leaves the predefinable region V, and the traffic control center does not have any information about whether the vehicle will continue to follow the calculated route R, the route-related data comprises information relating to the predefinable region V. It is thus possible to use route-related data in the vehicle even when a new route R₂ is followed to an intermediate destination ZZ₂ selected by the driver. This is because the route R₂ is completely covered by the region V. In contrast, it is not possible to use route-related data in the vehicle if the vehicle follows a new route R₁ to an intermediate destination ZZ₁ selected by the driver. This is because a large part of the route R₁ is not covered by the region V. As a result, it is always possible to check at the vehicle end whether a desired intermediate destination still lies inside the predefinable region V and/or whether the arrival time at the intermediate destination differs greatly from the original arrival time. In this case, new route-related data is requested from the traffic control centre in an automated fashion or when requested by the driver.

FIG. 11 shows the use of a time of arrival at the destination which is determined at the vehicle end, for determining the duration of the monitoring of the traffic disruption, or of each traffic disruption, in the traffic control center. So that the monitoring is not aborted too early—for example if the vehicle is traveling more slowly than estimated in the traffic control center—or too late—for example if the vehicle is traveling more quickly than estimated in the traffic control center—a time T₀ of arrival at the destination, which is determined at the vehicle end, is transmitted in a wireless fashion from the vehicle-mounted device to the traffic control center. A continuous comparison of the stored time T₀ of arrival at the destination with a currently determined time T_{A} of arrival then takes place at the vehicle end. If the currently determined time T_{A} of arrival differs from the stored time T₀ of arrival at the destination by more than a predefinable threshold value X (for example X=30 minutes), corresponding information is transmitted from the vehicle-mounted device to the traffic control center in an automated fashion or when requested, and the currently determined time T_{A} of arrival is written over the stored time T₀ of arrival at the destination. Then, a current time T_{A} of arrival is determined in turn. If the currently determined time T_{A} of arrival does not differ from the stored time T₀ of arrival at the destination by more than the predefinable threshold value X, a current time T_{A} of arrival is in turn determined.

FIG. 12 is a schematic illustration of the use of a location of a change in the route with a time of change in a calculated route. FIG. 12a is a schematic illustration of dynamic navigation from the starting location A to the destination location D. There are two possible connections here, specifically from the starting location A to the destination location D via location B, or alternatively from the starting location A to the destination location D via locations B and C. While the connection from location B to destination location D is shorter than to the destination location D via locations B and C, a traffic disruption VS is, however, temporarily located on the first alternative.

This traffic disruption VS gives rise to the travel time profile which is illustrated in FIG. 12b and which is designated by R1 for the first alternative and by R2 for the second alternative and indicates the time which is respectively required to travel from location B to destination location D for various times of arrival at the location B of a change in the route. The temporary increase in the travel time R1, caused by the traffic disruption VS, is clearly shown. Given an anticipated time of arrival of the vehicle at B of t_{E}, the connection via locations B and C to destination location D is therefore calculated as a route in the traffic control center since this is the fastest connection at the time t_{E}.

However, if the vehicle reaches the location B before the time tₘᵢₙ or after the time tₘₐₓ, this calculated route is no longer the fastest one. For this reason, the location B is transmitted as a location of a change in the route, with the times tₘᵢₙ and tₘₐₓ of change, from the traffic control center to the vehicle-mounted device. In addition, route-related data relating to the connection from location B to destination location D can also be transmitted to the vehicle-mounted device. In this case, when the vehicle arrives at the location B of the change in the route before tₘᵢₙ or after tₘₐₓ it is possible to change to the new route from location B to destination location D in an automated fashion or when requested. If corresponding route-related data is not available in the vehicle-mounted device for the alternative route at the location B of a change in the route, this route-related data is requested from the traffic control center in an automated fashion or when requested.

Alternatively, it is possible, as shown in FIG. 12c, to provide for a change in the route to be carried out by the vehicle only if the travel time is thus reduced by at least a certain amount Δt. In this case, if the vehicle arrives at the location B of a change in the route before t′ₘᵢₙ or after t′ₘₐₓ, the system would change to the new route from location B to destination location D in an automated fashion, or when requested. This procedure is suitable in particular if the vehicle-mounted device has to request new, usually cost-incurring, route-related data from the traffic control center.

FIG. 13 illustrates the use of locations of changes in routes with times of changes in a calculated route. In FIG. 13, the example from FIG. 2 is used, further calculations being carried out after FIG. 2f. Routes Rᵢ, i=1 . . . m on which the “relevant” traffic disruptions to be monitored are located were calculated in FIG. 2. Then, an earliest time of arrival t_{min, diver} and a latest time of arrival t_{max, driver} were assigned to each time of arrival of a traffic disruption according to parameters of a vehicle or driver, for example minimum and maximum average velocities which can be assumed. These times of arrival are obtained, for example, from the minimum and maximum assumed average velocity on the respective calculated route. A further calculation of a route is then carried out during which the costs max(Cₖ(t)), t∈└t_{min, driver,}t_{max, driver}┘ is used as costs (for example travel time) for an edge k with a traffic disruption to be monitored instead of the costs Cₖ(t_{E}) (where t_{E} is the anticipated arrival time of the vehicle at edge k). In other words, the travel times in the “most unfavorable” case are used. The costs with free traffic are used as costs of the remaining edges. As long as a newly calculated route Rⱼ differs here from the previously calculated route Rⱼ₋₁, all the traffic disruptions on Rⱼ are marked as to be monitored, and a further route is calculated. In FIG. 13a, the traffic disruptions 1, 2, A and B have become larger than in FIG. 2, and route R₆ is calculated and traffic disruption 4 is additionally monitored. The traffic disruption 4 which is additionally marked as to be monitored here is not transmitted from the traffic control center to the vehicle-mounted device.

Then, the location P is determined, for all the routes Rᵢ≠R_{A}(i=1 . . . m . . . n), as the location of a change in the route at which Rᵢ branches off from the route R_{A} which is “optimum” assuming an average velocity, and the location Q is determined at which the two routes meet again. The range of possible times of arrival └t_{min, driver,}t_{max, driver}┘ at the location P is determined and the anticipated travel times from P to Q with departure at P between t_{min, driver} and t_{max, driver} on the routes R_{A} and Rᵢ are compared. If it is present, the latest time tₘᵢₙ before the anticipated time of arrival t_{E} at the location P at which the travel time between P and Q on the route Rᵢ drops below the corresponding travel time on R_{A} by at least a predefined degree is calculated. If it is present, the earliest time tₘₐₓ after t_{E} for which this also applies is determined. In FIG. 13b, the locations P and Q on the route R_{A} are shown, as is the route R₆. FIG. 13c illustrates by way of example the travel times between P and Q on the routes R₆ and R_{A}. A time tₘᵢₙ does not exist here since between t_{min,driver} and t_{E} the travel time on R₆ is always higher than on R_{A}.

FIG. 14 shows which data relating to locations of changes in routes are transmitted from the traffic control center to the vehicle-mounted device. At each previously determined location Pᵢ(i=1 . . . n; Pᵢ is further away from the starting location S than Pⱼ for i>j) of a change in the route is checked to determine whether associated the time of arrival tₘᵢₙ(Pᵢ) is undershot or whether the time of arrival tₘₐₓ(Pᵢ) can be exceeded if the vehicle does not undershoot any of the times of arrival tₘᵢₙ(Pⱼ), j<i and does not exceed any of the times of arrival tₘₐₓ(Pⱼ), j<i, and neither undershoots an assumed minimum velocity vₘᵢₙ nor exceeds an assumed maximum velocity vₘₐₓ. Only if this condition is fulfilled is the time of arrival tₘᵢₙ(Pᵢ) or, respectively, tₘₐₓ(Pᵢ) transmitted to the vehicle, in which case the coordinates of Pᵢ are not transmitted either if neither tₘᵢₙ(Pᵢ) nor tₘₐₓ(Pᵢ) are to be transmitted.

With respect to FIG. 14, the following tₘᵢₙ(Pᵢ) and tₘₐₓ(Pᵢ) are transmitted: tₘᵢₙ(P₁) and tₘₐₓ(P₁) lie in the region which can be reached with velocities between vₘᵢₙ and vₘₐₓ, and are thus transmitted. In contrast, tₘᵢₙ(P₂) can no longer be undershot if the vehicle travels at vₘₐₓ and does not arrive at the point P₁ before tₘᵢₙ(P₁). If tₘₐₓ(P₁) and vₘᵢₙ are complied with, tₘₐₓ(P₂) cannot be exceeded. For this reason, the point P₂ is not transmitted to the vehicle. Point P₃ is transmitted since tₘₐₓ(P₃) could be exceeded, and tₘᵢₙ(P₃) is not transmitted.

Furthermore it is possible to provide for traffic disruptions to be monitored in the traffic control center only for as long as the vehicle is en route to the destination Z for the maximum time while complying with a minimum velocity which can be assumed and while complying with the time limits set by tₘₐₓ(Pᵢ), in which case, given a recalculation of the route, the part of the route which is at least traveled through is determined on the originally calculated route assuming a minimum velocity and compliance with tₘₐₓ(Pᵢ).

1-19. (canceled)

20: A method for dynamically navigating a vehicle, comprising:
requesting route-related data for a destination from a traffic control center in a wireless manner using a vehicle-mounted device;
calculating a route to the destination using the traffic control center and storing the calculated route;
transmitting the route-related data to the vehicle-mounted device in a wireless manner;
monitoring at least one traffic disruption that is not located on the calculated route using the traffic control center; and
at least partially recalculating the route to the destination as a recalculated route when the at least one traffic disruption decreases.

21: The method as recited in claim 20, further comprising monitoring all traffic disruptions located in a predefinable region around the calculated route.

22: The method as recited in claim 20, further comprising comparing the calculated route with the recalculated route, and, if the recalculated route differs from the calculated route, transmitting information from the traffic control center to the vehicle-mounted device.

23: The method as recited in claim 22, wherein the information includes a location of a change in the route and a time of a change in the calculated route to the vehicle-mounted device.

24: The method as recited in claim 20, wherein the route is recalculated only if the traffic disruption decreases by more than a predefinable degree.

25: The method as recited in claim 20, wherein the route-related data is in the form of traffic data.

26: The method as recited in claim 20, wherein the route-related data is in the form of route data.

27: The method as recited in claim 25, wherein the route-related data includes information relating to the course of the calculated route.

28: The method as recited in 21, further comprising transmitting in a wireless manner information relating to the predefinable region between the vehicle-mounted device and the traffic control center.

29: The method as recited in claim 20, further comprising recomputing at least a portion of the calculated route through which the vehicle has not yet traveled.

30: The method as recited in claim 29 wherein a minimum velocity is assumed for the recomputing.

31: The method as recited in claim 29, wherein the recomputing includes calculating at least three times using at least three respective assumed average velocities for the vehicle.

32: The method as recited in claim 20, wherein the monitoring of the at least one traffic disruption is performed for at least for a period of time estimated at the traffic control center for the vehicle to reach the destination.

33: The method as recited in claim 20, further comprising determining a time of arrival at the destination using the vehicle and transmitting the time of arrival in a wireless manner from the vehicle-mounted device to the traffic control center.

34: The method as recited in claim 20, further comprising determining the at least one traffic disruption, wherein the determining includes:
in a first step, calculating an R₁ route to the destination without taking into account traffic disruptions;
in a second step, calculating an R_{A} route to the destination taking into account all traffic disruptions;
in a third step, monitoring all traffic disruptions on the R₁ route and calculating an R₂ route to the destination taking into account only those traffic disruptions which have already been monitored;
in a fourth step, monitoring all traffic disruptions on the previously calculated Rᵢ route, i≧2, and calculating an Rᵢ₊₁ route to the destination taking into account the monitored traffic disruptions; and
repeating the fourth step until the Rᵢ route corresponds to the R_{A} route, and all the possibly existing traffic disruptions on the R_{A} route have been monitored in a previous step.

35: The method as recited in claim 34, wherein the number of Rᵢ routes to be calculated is limited to a predefinable maximum value n.

36: The method as recited in claim 35, further comprising further calculating Rᵢ routes.

37: A computer program executable on a computer and having a program code for carrying out all the steps of claim 20.

38: A computer program product executable on a computer and having program code stored on a computer-readable data carrier, the program code capable of carrying out the steps of claim 20.

39: A system for dynamically navigating a vehicle, comprising:
a vehicle-mounted device; and a
a traffic control center, the traffic control center including:
a receiver for receiving wireless requests of route-related data from the vehicle-mounted device, wherein the route-related data relates to a destination of the vehicle;
a calculation device configured to calculate a route to the destination of the vehicle;
a storage device configured to store the calculated route;
a transmitter configured for wireless transmission of the route-related data to the vehicle-mounted device; and
a monitoring device configured to monitor at least one traffic disruption not located on the calculated route.
